(19) United States
(12) Patent Application Publication
(10) Pub. No.: US 2008/0304801 A1
(43) Pub. Date: Dec. 11, 2008

(54) High-brightness light guide plate

(75) Inventors: Chao-Pai Lee, Taichung (TW); Chih-Tsung Lin, Taichung (TW); Tzu-Wen Su, Taichung (TW)

Correspondence Address: Chao-Pai Lee, P. O. Box 55-124, TAICHUNG, TW

(73) Assignee: JENG SHIANG PRECISION IND. CO., LTD.

(21) Appl. No.: 11/808,426

(22) Filed: Jun. 11, 2007

(51) Int. Cl. G02B 6/10

(52) U.S. Cl. 385/129

(57) ABSTRACT

The present invention discloses a high-brightness light guide plate, which is a plate formed by a transparent resin having a high refractive index. An incident plane is disposed on a lateral side of the light guide plate, and a light emitting plane is disposed on a surface of the light guide plate. A reflective plane is disposed on a backside of light guide plate facing the light emitting plane and the light guide plate has a plurality of cells sunken into the reflective plane to form a diffusion pattern. The light guide plate has a plurality of diffusion points embossed at the light emitting plane, and each diffusion point is disposed on the light emitting plane, such that the manufacturing cost of a light guide plate mold can be lowered by improving the taste and the uniformity.

### FIELD OF THE INVENTION

The present invention relates to a component of a plane light source device, and more particularly to a high-brightness light guide plate.

### BACKGROUND OF THE INVENTION

In general, a conventional plane light source device includes a light guide plate, a light emitting portion, and a reflector, and the light guide plate is made of a transparent resin having a high refractive index, and a diffusion pattern composed of cells is formed at the backside of the light guide plate. A light incident plane is disposed on a lateral side of the light guide plate, and the light emitting portion is facing the light incident plane, such that light can be projected into the light guide plate, and the reflector is a plate attached on a backside with a diffusion pattern of the light guide plate and having a high reflective index.

The light projected into the light guide plate through the light incident plane of the light emitting portion has total internal reflection occurred repeatedly on a surface and a backside of the light guide plate, and the light is closed at the interior of the light guide plate and transmitted to a direction away from the light emitting portion, such that when the light transmitted into light guide plate is projected to the backside of the light guide plate, a portion of the light is totally reflected to the surface of the light guide plate (which is a light emitting plane) by the diffusion pattern. By then, the light is reflected to the light emitting plane by an angle smaller than the critical angle of the total internal reflection, and reflected to the exterior of the light guide plate through the light emitting plane, and another portion of the light that is not totally reflected by the diffusion pattern is reflected back into the light guide plate by the reflector and closed in the light guide plate again, so that the reflection by the reflector can reduce the energy loss at the backside of the light guide plate.

Since the light emitted from the light emitting plane of the light guide plate is emitted from a medium of a large refractive index to a medium of a small refractive index, therefore the light is emitted in a direction deviated from the normal of the light emitting plane. Assumed that the direction along the light incident plane is defined as X-axis, and the direction perpendicular to the light incident plane is defined as Y-axis, the light passing from the interior of the light guide plate and emitting from the light emitting plane is a slender directional light substantially along the Y-axis. Since the effective visual angle of human eye is approximately equal to 5°-10°, and our eyes cannot see any light beyond the range of such visual angle, therefore the light emitted from the light emitting plane cannot be received completely by human eyes. In this situation, the light emitted from the light guide plate has a lower brightness when viewing in a direction perpendicular to the light emitting plane, and thus is unfavorable to the light emission efficiency of the light emitting portion. In a conventional plane light source device, a prism is usually installed at the top of the light emitting plane of the light guide plate, so that the light emitted from the light emitting plane is focused at a position close to the Z-axis by the prism to enhance the brightness of the visual light.

If the light emitted from the light emitting plane is a directional light, then the light will be close to a direction perpendicular to the light emitting plane (Z-axis), and more light will enter into the effective visual angle of our eyes. Therefore, the prism is no longer needed for enhancing brightness of light disposed at the Z-axis and emitted from the light guide plate, so as to improve the light emission efficiency of the light emitting portion and reduce the volume and the manufacturing cost of the plane light source device.

On the other hand, the conventional plane light source device uses a light emitting component at the light emitting portion as a light source, and there are two types of light emitting components: cold cathode fluorescent lamp (CCFL) and light emitting diode (LED), wherein a light emitting component installs a plurality of LEDs to form several point light sources, and the point light sources project light in a radiating form to the interior of the light guide plate through the light incident plane. The cells that constitute the diffusion pattern of a conventional light guide plate have an interface of refractive and reflective lights parallel to the light incident plane, viewing from the Z-axis, such that when the light transmitted into the light guide plate is projected to the diffusion pattern, only a portion of the light is reflected to the light emitting plane totally by the diffusion pattern. Since a mixed light distance exists between LEDs, bright and dark zones will occur easily, particularly for the bright and dark zones of the light guide plate having a mirror-surface pattern, obviously bright lines and dark fringes are formed, and it is necessary to use a diffuser to diffuse the light emitted from the light guide plate. As a result, the brightness of the light emitted along the Z-axis from the light guide plate is reduced, which is unfavorable to the light emission efficiency of the light emitting portion.

To solve the problem of the forgoing conventional light guide plate, the inventor of the present invention filed patent applications entitled “High-brightness light guide plate (R.O.C. Pat. Publication No. 1279627 and P.R.C. Pat. Publication No. CN2857040Y), that uses a diffusion pattern to enhance the brightness of the light emitted from the light guide plate and along the direction perpendicular to the light emitting plane, so as to improve the light emission efficiency of the plane light source device and reduce the volume and manufacturing cost of the plane light source device, and also evenly distribute the light emitted from the light guide plate on the light emitting plane to avoid bright lines and dark fringes.

If a mold is produced in accordance with the aforementioned patented invention, it is necessary to design the specific dimensions and distributions of cells of a diffusion pattern first, and a mirror-surface mold core formed by a plurality of embosses is made according to the design, and then the mold core is put into a mold to form the mold surface of the shaped reflective plane, and the embosses of the mold core are used for producing a test sample of the light guide plate and distributing a plurality of cells on the reflective plane to form a diffusion pattern, and the test sample is tested and checked whether or not it achieves the expected effects of high brightness and free of bright liens. If the expected effects are not achieved, then it is necessary to abandon the previously designed mirror surface and mold core and redesign the dimensions and distribution of the cells and go through the processes of producing a mold core, forming a test sample, and testing the test sample. With repeated modifications, trials and testing, the mold for producing a light guide plate in mass production can be made.

In general, the distribution of cells has a direct effect on the occurrence of bright lines and dark fringes when the light is passed through the light emitting plane. In the industry, the evaluation on the balance of brightness is called taste, and the distribution of cells can be adjusted to achieve the expected taste and uniformity of the backlight module, but this method sometimes requires 20 times of repeated modifications, trials and testing for producing a set of mold for the mass production of the light guide plates. In other words, the mirror-surface mold is abandoned and resigned for every modification. Since the manufacture of the mirror-surface mold core requires high precision and high level of technology, therefore the manufacturing cost is high. The more the repeated modifications, the higher is the cost for the mirror-surface mold core. With the trials and testing, the overall cost and manpower required for producing a mold will be very high.

In view of the foregoing shortcomings of the prior art, the inventor of the present invention based on years of experience in the related industry to conduct extensive researches and experiments to modify the taste and uniformity and lower the manufacturing cost of the mold, and finally developed a high-brightness light guide plate in accordance with the present invention.

### SUMMARY OF THE INVENTION

The primary objective of the present invention is to provide a high-brightness light guide plate that forms diffusion points on a light emitting plane, and thus it is not necessary to adjust the distribution of cells of the diffusion pattern for modifying the taste and the uniformity, so as to quickly modify a mold core, and lower the manufacturing cost of a light guide plate mold.

To achieve the foregoing objective, the present invention provides a high-brightness light guide plate which is a plate made of a transparent resin having a high refractive index. An incident plane is disposed on a lateral side of the light guide plate, and a light emitting plane is disposed on a surface of the light guide plate, and a reflective plane is disposed on a backside of light guide plate facing the light emitting plane, and the light guide plate has a plurality of cells sunken into the reflective plane to form a diffusion pattern. The light guide plate has a plurality of diffusion points embossed at the light emitting plane, and each diffusion point is disposed on the light emitting plane, such that the manufacturing cost of a light guide plate mold can be lowered by improving the taste and the uniformity.

### BRIEF DESCRIPTION OF THE DRAWINGS

FIG. 1 is a section view of a first preferred embodiment of the present invention;

FIG. 2 is an enlarged section view of a part of a diffusion point portion of FIG. 1;

FIG. 3 is a schematic view of the distribution of diffusion points in accordance with a first preferred embodiment of the present invention;

FIG. 4 is an enlarged view of a part of a diffusion point portion of FIG. 3;

FIG. 5 shows the distribution of brightness of a light guide plate without diffusion points; and

FIG. 6 shows the distribution of brightness of the present invention.

### DETAILED DESCRIPTION OF PREFERRED EMBODIMENT

To make it easier for our examiner to understand the present invention, the following detailed description with reference to the accompanying drawings of embodiments are given for example, but such preferred embodiment is not intended to limit the scope of the present invention. For simplicity, like numerals are used for like elements for the description of the specification of the present invention.

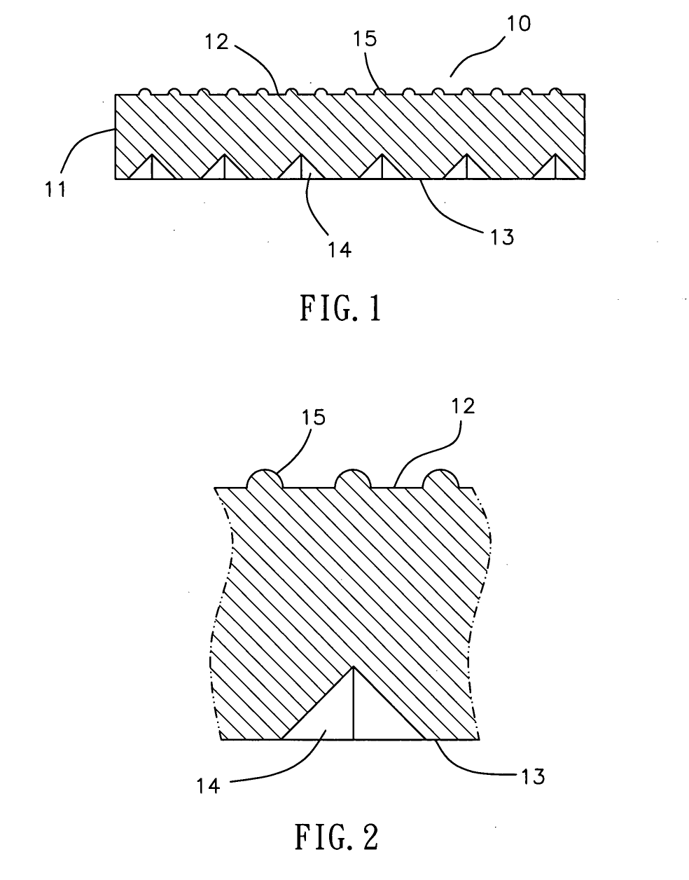

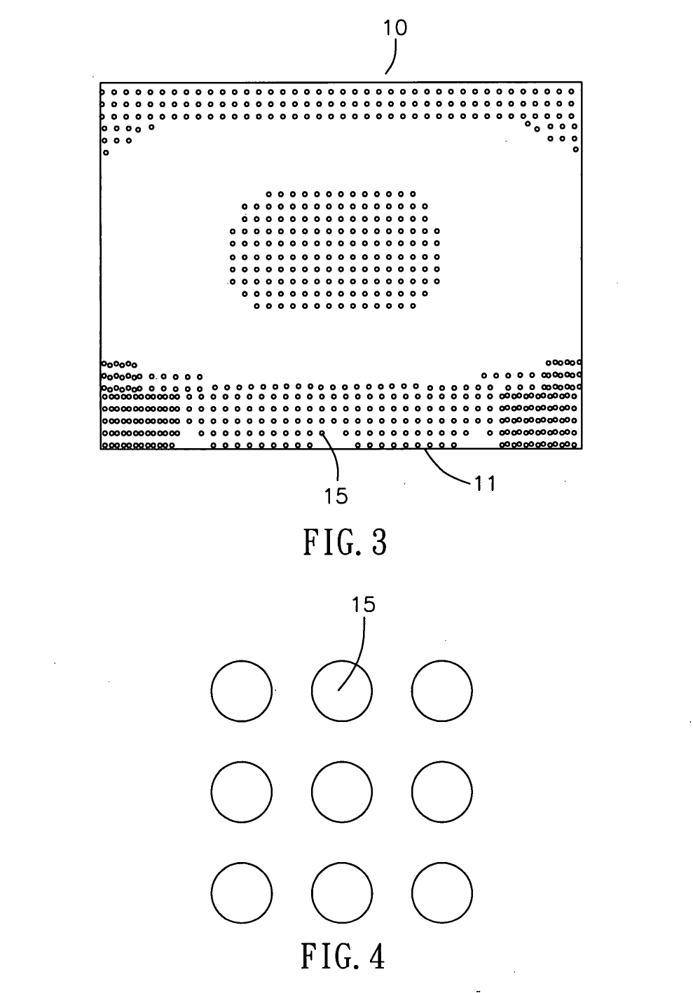

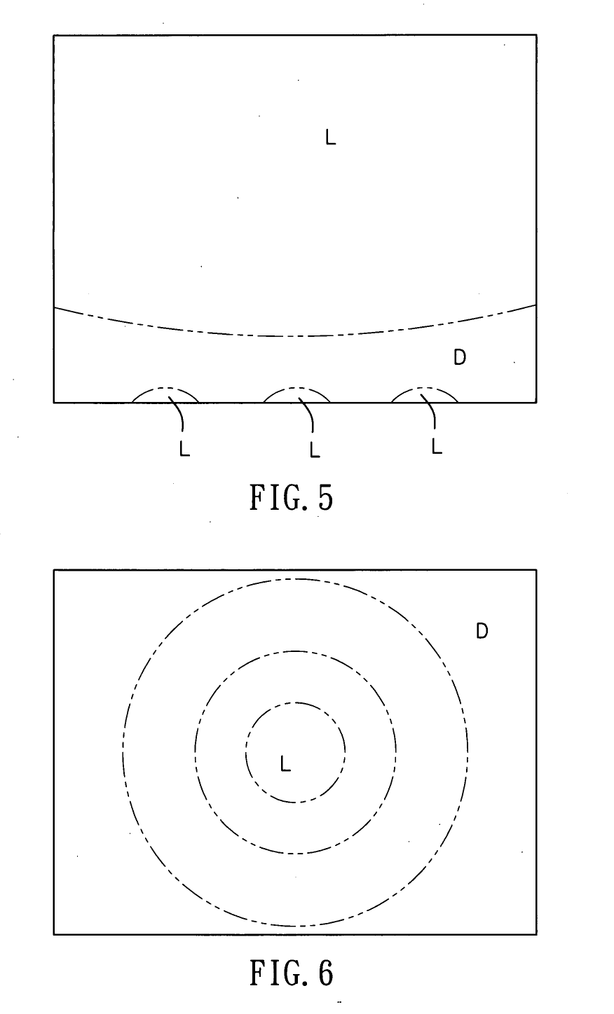

Referring to FIG. 1 for a high-brightness light- guide plate 10 of the present invention, the high-brightness light guide plate 10 is a plate made of a transparent resin having a high refractive index. A light incident plane 11 is disposed on a lateral side of the light guide plate 10, and a light emitting plane 12 is disposed on a surface of the light guide plate 10, and a reflective plane 13 is disposed on a backside of the light emitting plane 12 facing the light guide plate 10 and parallel to the light emitting plane 12. The light guide plate 10 has a plurality of cells 14 sunken into the reflective plane 13 to form a diffusion pattern, and this part is the same as the aforementioned patented invention, and thus will not be described in detail here. Referring to FIGS. 2 to 5, a plurality of diffusion points 15 are embossed on the light emitting plane 12 of the light guide plate 10, and each diffusion point 15 is substantially in a hemispherical arch shape, and distributed on the light emitting plane 12 according to the optical track of the light emitted from the light emitting plane 12, so that the light emitted from the light guide plate 10 can be distributed uniformly, and bright lines and dark fringes can be avoided, so as to improve the taste and the uniformity, and lower the manufacturing cost of a light guide plate mold. Referring to FIGS. 5 and 6, the light track is guided by the surface of the diffusion points 15 and diffused and projected to the wide surface area, when the light is passed through the light emitting plane 12, and thus bright lines and dark fringes can be avoided. When the mold of the present invention is produced, it is not necessary to repeatedly modify the distribution of cells 14 of the diffusion pattern to the best taste and uniformity. Even the taste and the uniformity are in the condition as shown in FIG. 5, (where L stands for a light area, and D stands for a dark area), the bright lines and dark fringes can be avoided by forming the diffusion points 15, so as to achieve the effects of improving the taste and the uniformity (as shown in FIG. 6) and the distribution of brightness as shown in FIG. 6. The brightness is decreased progressively from the center of the light guide plate to the periphery, so as to give the ideal taste and uniformity, and greatly simplify the procedure of repeatedly modifying the mirror-surface mold core for forming a diffusion pattern, and reducing the number of times of the trials and testing. In actual testing, the distribution of cells of the diffusion pattern can be improved to increase the light emitting angle from the Z-axis. The optical track of the light passing through the light emitting plane determines the distribution of the diffusion points 15, and thus it is only necessary to modify three to five mirror-surface mold cores required by the diffusion pattern to produce the mirror-surface mold cores required by the diffusion pattern, and use the surface of the cavity formed on the mold core as the surface of a mold for forming the light emitting plane to facilitate the injection molding of the light guide plate, so that the light guide plate forms the diffusion points 15 on the light emitting plane. Since the mold cores have a mirror-surface mold core, therefore the precision and technological level required for manufacturing the mirror-surface mold core of this type are obviously lower than those of the general mirror-surface mold cores in order to form the required light emitting plane 12 and diffusion points 15. In addition, the manufacturing cost is much lower than that of the general mirror-surface mold core required for forming the diffusion pattern, and the mirror mold core of this type can be modified quickly to greatly save development time. By forming the diffusion points 15, the present invention can modify the taste and the uniformity quickly, so that the mold for manufacturing light guide plates in mass production can be made to greatly lower the overall cost and effectively reduce the manufacturing time of the mold.

In summation of the description above, the present invention enhance the prior art and also complies with the patent application requirements. The description and its accompanied drawings are used for describing preferred embodiments of the present invention, and it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

1. A high-brightness light guide plate, which is a plate made of a transparent resin having a high refractive index, and a light incident plane is disposed on a lateral side of the light guide plate, a light emitting plane is disposed on a surface of the light guide plate, a light emitting plane is disposed on a backside of the light guide plate opposite to the light emitting plane, a reflective plane is disposed on the corresponding backside, the light guide plate has a plurality of cells sunken into the reflective plane to form a diffusion pattern; thereby the light guide plate has a plurality of diffusion points embossed at the light emitting plane, and each diffusion point is disposed on the light emitting plane.

2. The high-brightness light guide plate of claim 1, wherein the diffusion point is substantially in a hemispherical arc shape.
